(19) United States
(12) Patent Application Publication
(10) Pub. No.: US 2011/0113553 A1
(43) Pub. Date: May 19, 2011

(54) Bed Bug Entrance/Exit Resistant Cover

(76) Inventors: Kara Johan, Orange, CA (US); Joseph Reyes, Fontana, CA (US); Kenneth Scott Siegner, Calimesa, CA (US)

(21) Appl. No.: 12/619,007

(22) Filed: Nov. 16, 2009

(51) Int. Cl. A47C 31/00; B68G 7/05

(52) U.S. Cl. 5/499; 29/91.1

(57) ABSTRACT

A bed bug resistant cover for a mattress includes a plurality of panels of fabric material connected by seams that are RF welded. The connected plurality of panels include a first opening for receiving the mattress and a second opening serving as a vent. A zipper assembly is cooperable with the panels of fabric material and RF welded to the opening to close the panels of fabric material over the mattress. A filter is RF welded to an inside surface of the panels of fabric material and covers the vent.

### CROSS-REFERENCES TO RELATED APPLICATIONS

(Not Applicable)

### STATEMENT REGARDING FEDERALLY SPONSORED RESEARCH OR DEVELOPMENT

(Not Applicable)

### BACKGROUND OF THE INVENTION

The invention relates to a protective mattress cover and, more particularly, to a bed bug resistant cover for mattresses.

By the nature of how a mattress is used for rest or sleep, it is frequently in close contact with humans that may shed dead skin, for example, or discard other organic substances that are retained in the mattress. Insects such as dust mites or “bed bugs” can thrive on this organic matter and quickly develop into a significant population within the mattress. Dust mites or bed bugs can bite someone using a bed, resulting in substantial discomfort.

College dormitories, summer camps and the like provide housing for students/campers/etc. using an inventory of mattresses. It is burdensome to require individuals to bring their own mattresses, and it is expensive to regularly replace mattresses with new ones. A single mattress that has been purchased by a residence hall manager may be used as a sleeping surface by many individuals over the service life of the mattress. As a consequence dust mite and bed bug infestation in mattresses is an ongoing problem

It would be desirable for a mattress cover to prevent bed bugs and/or dust mites from developing a population within a mattress and also to prevent any dust mites within a mattress from reaching a person using the mattress.

### BRIEF SUMMARY OF THE INVENTION

According to preferred embodiments, a bed bug resistant cover has all its seams sealed and welded using radio frequency (RF) welding, resulting in a water-resistant, therefore bed bug resistant, cover. A water-resistant zipper is RF welded onto the opening of the cover, and a filter is added for breathability. The construction prevents dust mites from infesting the mattress and also prevents any dust mites within the mattress from accessing a person using the mattress.

In an exemplary embodiment, a bed bug resistant cover for a mattress includes a plurality of panels of fabric material connected by seams that are RF welded. The connected plurality of panels include a first opening for receiving the mattress and a second opening serving as a vent. A zipper assembly is cooperable with the panels of fabric material and RF welded to the qpening to close the panels of fabric material over the mattress. A filter is RF welded to an inside surface of the panels of fabric material and covers the vent. The zipper assembly may include a zipper pull and a zipper, where the zipper pull may be attached to the inside surface of the panels of fabric material.

The filter is preferably a dense fiber filter. A mesh screen, preferably formed of polypropylene may be disposed covering the filter. In one arrangement, the filter is disposed at a foot end of the cover.

Ends of the zipper assembly may be sealed with a sealant such as a silicone sealant.

In another exemplary embodiment, a bed bug resistant cover for a mattress includes a top panel, a bottom panel, and side panels connecting the top and bottom panels via RF welded seams. A first opening is provided between the top and bottom panels for receiving the mattress, and a second opening is provided and serves as a vent. A zipper assembly cooperable with the panels is RF welded to the opening. A filter formed of dense fiber is RF welded to an inside surface of one of the panels to cover the vent. A polypropylene mesh screen is provided to cover the filter. For standard size mattresses, the top cover and bottom cover may fold over the edge and meet at a center seam. Side panels are preferable for large mattresses.

In yet another exemplary embodiment, a method of assembling a bed bug resistant cover for a mattress includes the steps of connecting a plurality of panels of fabric material by RF welding seams between the plurality of panels and including a first opening for receiving the mattress and a second opening serving as a vent; RF welding a zipper assembly to the opening to close the panels of fabric material over the mattress; and RF welding a filter to an inside surface of the panels of fabric material to cover the vent.

### BRIEF DESCRIPTION OF THE DRAWINGS

These and other aspects and advantages of the present invention will be described in detail with reference to the accompanying drawings, in which:

FIG. 1 is a perspective view of the mattress cover;

FIG. 2 is an end view showing the zipper enclosure, and FIG. 2A is a close-up view of the zipper enclosure;

FIG. 3 is an end view showing the filter and screen, and FIG. 3A is a close-up view of the filter;

FIG. 4 is a sectional view showing the zipper assembly welded to an opening in the cover; and

FIG. 5 shows an alternative embodiment using a silicone seal.

### DETAILED DESCRIPTION OF THE INVENTION

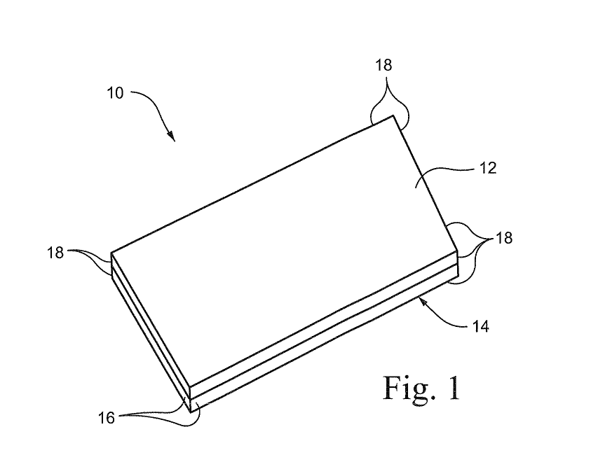

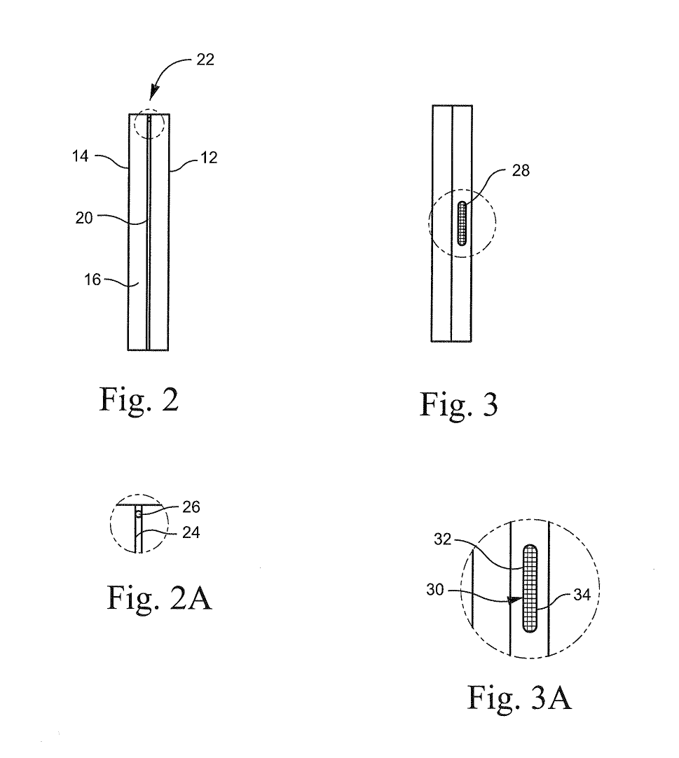

With reference to FIG. 1, a bed bug resistant cover 10 for a mattress includes a top panel 12, a bottom panel 14 and side panels 16 connecting the top and bottom panels via seams 18. An opening 20 is provided between the top and bottom panels 12, 14 (see FIG. 2) for receiving the mattress. The opening 20 may be formed at a midsection of one or more of the side panels 16. The size and positioning of the opening 20 is not critical, although a larger opening will facilitate installation of the mattress cover on a mattress but also will extend the length of the closing structure.

A zipper assembly 22 is cooperable with the panels 12, 14, 16 and secured to the opening 20. As shown in FIG. 2A, the zipper assembly 22 includes a zipper enclosure 24 and a zipper pull 26. In a preferred arrangement, the zipper pull 26 may be attached to an inside surface of the side panels 16. The zipper pull 26 may alternatively be attached to an outside surface.

With reference to FIG. 3, the cover 10 additionally includes a vented opening 28 to allow for breathability of the cover 10. As shown in FIG. 3A, a filter assembly 30 is secured to an inside surface of one of the panels (preferably in a side panel 16 at the foot end of the mattress cover 10). The filter assembly includes a filter 32, such as a dense fiber filter and a polypropylene mesh screen 34 disposed covering the filter 32. The mesh screen 34 serves to protect the filter 32 from being damaged. Any suitable filter may be used such as those designed for screening out microbes in a medical environment. One suitable filter is a Viledon filter available from Freudenberg Filtration Technologies, having a U.S. office in Hopkinsville, Kentucky.

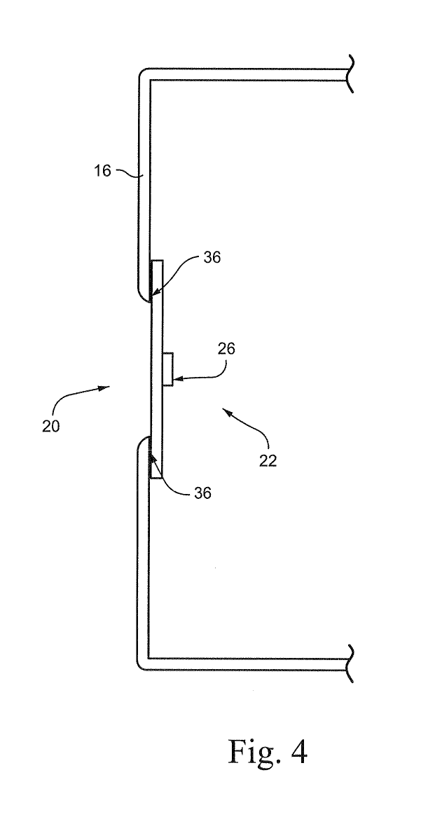

In a preferred construction, all of the seams 18 between the panels 12, 14, 16 are RF welded to allow for a water-resistant, therefore bed bug resistant, seam. The zipper assembly 22 is also RF welded to the inside surface of one of the panels 12, 14, 16 over the opening 20. FIG. 4 is a cross-sectional view showing the zipper assembly 22 secured to the side panel 16 at RF weld points 36. The zipper assembly 22 is secured to the side panel 16 such that the zipper pull 26 may be attached to the inside surface of the side panel 16.

The preferred cover material is transfer coated polyurethane (TCP) backed Nylon. The material may be coated with polyurethane.

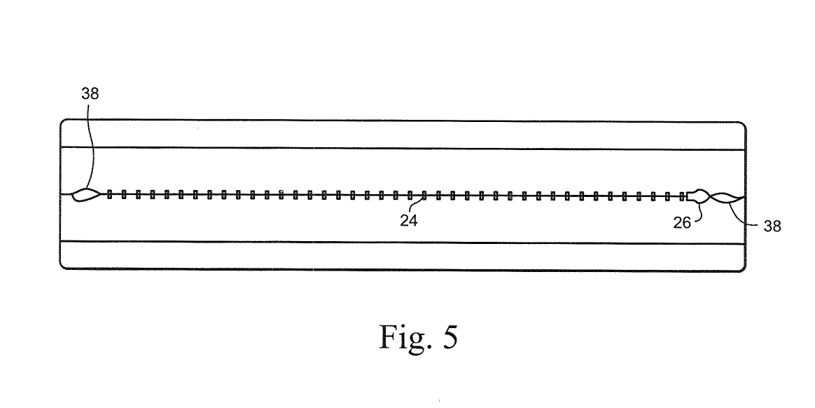

In an alternative arrangement, with reference to FIG. 5, ends of the zipper assembly 22 may be sealed with a sealant 38, such as silicone.

With the structure of the described mattress cover, by RF welding the seams between panels, a dust mite proof cover can be obtained that prevents infestation as well as access by any existing infestation to a person using the mattress. The RF welded zipper assembly facilitates insertion of a mattress within the cover and maintains the resistance to infiltration. Additionally, an RF welded filter with a protecting screen provides breathability to the mattress cover.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims

1. A bed bug resistant cover for a mattress, comprising:
a plurality of panels of fabric material connected by seams, wherein the seams are RF welded, the connected plurality of panels including a first opening for receiving the mattress and a second opening serving as a vent;
a zipper assembly cooperable with the panels of fabric material and RF welded to the opening to close the panels of fabric material over the mattress; and
a filter RF welded to an inside surface of the panels of fabric material and covering the vent.

2. A bed bug resistant cover according to claim 1, wherein the zipper assembly comprises a zipper pull and a zipper, wherein the zipper pull is attached to the inside surface of the panels of fabric material.

3. A bed bug resistant cover according to claim 1, wherein the filter is a dense fiber filter.

4. A bed bug resistant cover according to claim 1, further comprising a mesh screen disposed covering the filter.

5. A bed bug resistant cover according to claim 4 wherein the mesh screen comprises a polypropylene screen.

6. A bed bug resistant cover according to claim 1, wherein the filter is disposed at a foot end of the cover.

7. A bed bug resistant cover according to claim 1, wherein ends of the zipper assembly are sealed with a sealant.

8. A bed bug resistant cover according to claim 7, wherein the sealant comprises silicone.

9. A bed bug resistant cover for a mattress, comprising:
a top panel;
a bottom panel, the top and bottom panels being connected via seams, wherein the seams are RF welded;
a first opening between the top and bottom panels for receiving the mattress;
a second opening serving as a vent;
a zipper assembly cooperable with the panels and RF welded to the opening;
a filter formed of dense fiber and RF welded to an inside surface of one of the panels, the filter being disposed covering the vent; and
a polypropylene mesh screen disposed covering the filter.

10. A bed bug resistant cover according to claim 9, wherein the zipper assembly comprises a zipper pull and a zipper, wherein the zipper pull is attached to the inside surface.

11. A bed bug resistant cover according to claim 9, wherein the filter is disposed at a foot end of the cover.

12. A bed bug resistant cover according to claim 9, wherein ends of the zipper assembly are sealed with a sealant.

13. A bed bug resistant cover according to claim 12, wherein the sealant comprises silicone.

14. A bed bug resistant cover according to claim 9, further comprising side panels connecting the top and bottom panels via the seams.

15. A method of assembling a bed bug resistant cover for a mattress, the method comprising:
connecting a plurality of panels of fabric material by RF welding seams between the plurality of panels and including a first opening for receiving the mattress and a second opening serving as a vent;
RF welding a zipper assembly to the opening to close the panels of fabric material over the mattress; and
RF welding a filter to an inside surface of the panels of fabric material to cover the vent.
